(19) United States
(12) Patent Application Publication
(10) Pub. No.: US 2017/0011315 A1
(43) Pub. Date: Jan. 12, 2017

(54) REAL-TIME RISK DRIVEN PRODUCT DEVELOPMENT MANAGEMENT (RDPDM) AND ITS PROJECT DELIVERABLE MAP

(71) Applicant: JIN XING XIAO, San Diego, CA (US)

(72) Inventor: JIN XING XIAO, San Diego, CA (US)

(21) Appl. No.: 14/797,147

(22) Filed: Jul. 12, 2015

(51) Int. Cl. G06Q 10/06

(52) U.S. Cl. CPC G06Q 10/0635

(57) ABSTRACT

In 2013, Jin Xing Xiao created a patent “RISK DRIVEN PRODUCT DEVELOPMENT SYSTEM” (publication #US-2015-0134398-A1) which provides a generally structured product development process driven by risk management. This new patent plans to extend the above studies and researches in the following areas:

Developing a wide range of FMEA tools. A new set of FMEA tools includes the Market FMEA, Service FMEA, System FMEA, Application FMEA, Design FMEA, Software FMEA, Clinical FMEA, Compliance FMEA, Package FMEA, Process FMEA, and Supplier FMEA (collectively called as xFMEA).

Driving a product development system by real-time risk management. In any development phases/sub-phases, risk management is implemented on each project deliverable to ensure its potential risks are reduced as far as possible. When the product development flows from one phase/sub-phase to the next one, the overall residual risks are verified that the benefits outweigh risks.

Generating an intuitively customized project deliverable map. Based on a particular customer product, a customized project deliverable map is created systematically. Each deliverable requirement is assigned to a specific development group (Market, Technical Service, R&D, Medical Science, Regulatory Affairs, Supplier Quality, Quality, Operations, Risk Management, and Project) and scheduled to a specific product development sub-phase and phase. Furthermore, any deliverable requirements are allowed to be reassigned to another group and development phase as needed. An example map with 166 project deliverable requirements are provided.

### BACKGROUND OF THE INVENTION

1. Field of the Invention

This invention relates to the new product development process, and more specifically, relates to product development for medical devices. The invention describes a new framework of product development processes mainly contributed by FDA Design Control Guidance (planning, input, designing, output, review, verification, validation, transfer, and change), Process Development (development, validation, transfer), and risk management tools (FMEAs).

2. General Background of Invention

PDP (Product Development Process) is a business process to bring a new product to markets. In general, PDP has the functions of idea generation, idea screening, concept development & testing, business analysis, prototype testing, technical implementation, regulatory submission, clinical studies, and commercialization. An excellent PDP has a capability to develop a high quality product faster, low cost, less risk, and greater profit.

In 2013, Jin Xing Xiao created the patent “Risk Driven Product Development System” (publication number US-2015-0134398-A1). In the above patent, a framework of RPDP was defined which includes 4 phases (product plan, product design, process development, product service) and of 13 sub-phases (business case, design planning, design input, design, design output, design verification, design validation, design transfer, process development, process validation, process transfer, product launch, post market). The development flow is driven by several FMEA risk management tools from one sub-phase/phase into the next sub-phase/phase.

### SUMMARY OF THE INVENTION

The current invention creates a wide range of FMEA tools which work together harmoniously in the entire course of product development for driving the project activities. The set of FMEA tools includes Market FMEA, Service FMEA, System FMEA, Application FMEA, Design FMEA, Software FMEA, Clinical FMEA, Compliance FMEA, Package FMEA, Process FMEA, and Supplier FMEA.

The current invention creates a product development system driven by real-time risk management. Each project deliverable is dominated by a specific FMEA tool and each project sub-phase/phase is dominated by a group of FMEA tools in order to reduce overall potential risks as far as possible.

The current invention creates a customized project deliverable map. The intuitive map is used to guide the project development and implement the real-time risk management. An example map with 166 project deliverable requirements is demonstrated that the new product is in line with the physical features (mechanical, electrical, software components), reliability features (re-usable, shelf life), biocompatibility features, and regulatory affair requirements (FDA, EU, ROW).

### BRIEF DESCRIPTION OF THE DRAWINGS

A more complete understanding of the present inventions may be derived by referring to the detailed description and claims when considered in connection with the Figures, where like reference numbers refer to similar elements throughout the Figures, and:

FIG.1 is a block diagram illustrating the Real-Time Risk driven Product Development Process (RdPDP);

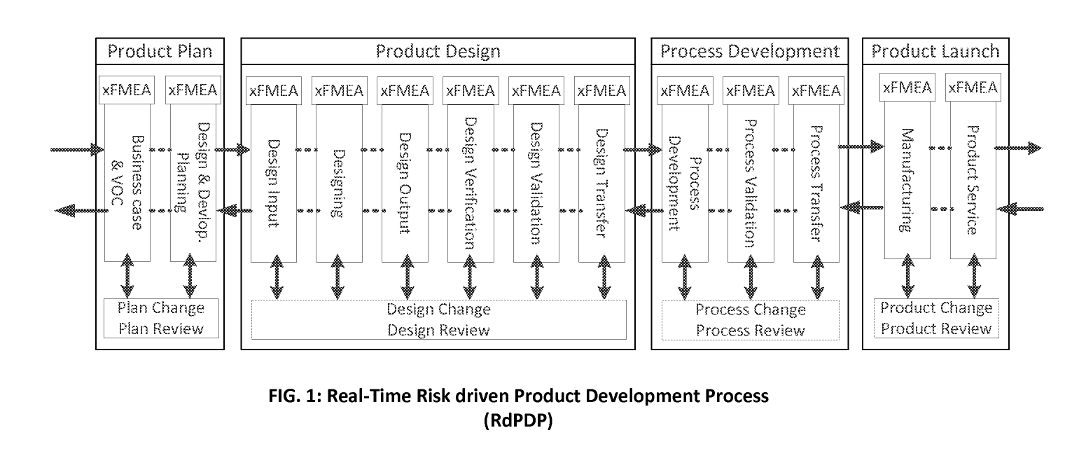

FIG. 2 is a block diagram illustrating a project map with 166 deliverable requirements. Each project requirement is assigned to a specific development group and scheduled to a specific product development sub-phase and phase.

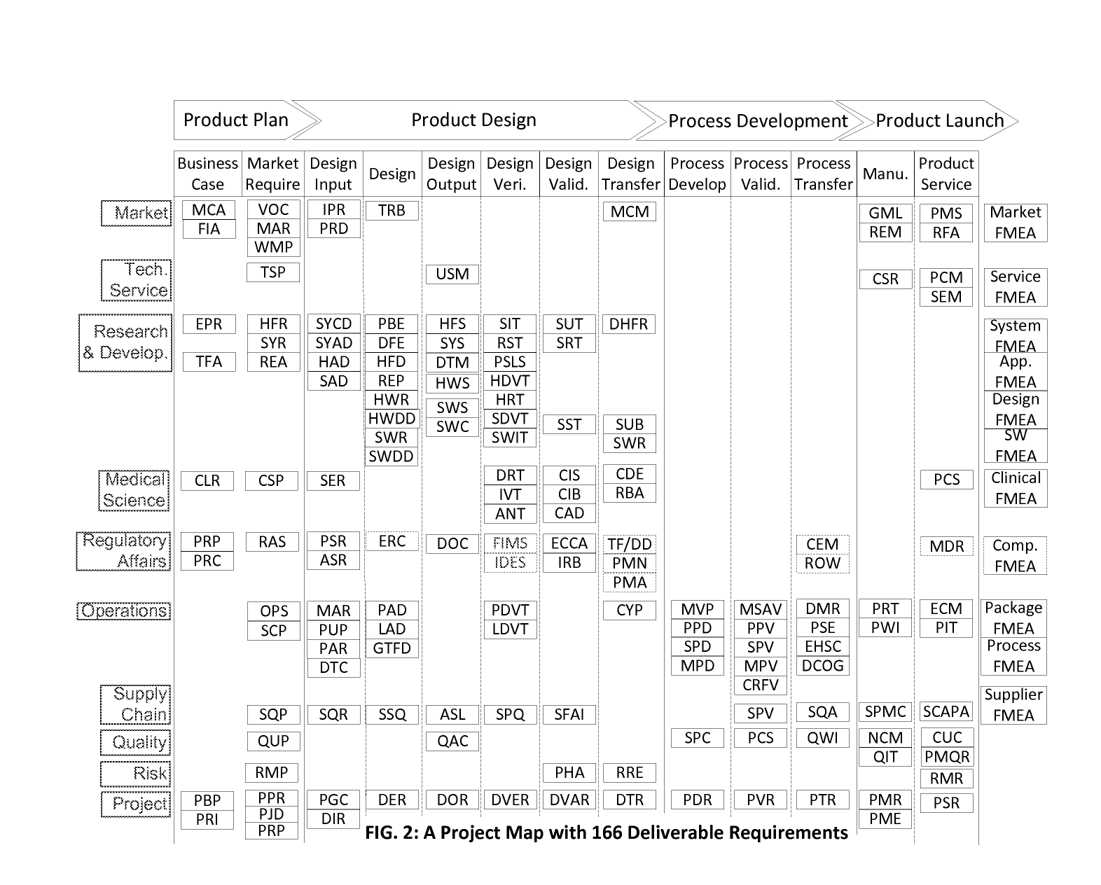

### DETAILED DESCRIPTION

Risk driven Product Development Process (RdPDP) is applied to facilitate a new product development starting from customer voices, product plan, product design, process development, to product launch.

Product Plan Phase: Once a project is initiated, Market group shall evaluate the new product strength/weakness/opportunity/threat (MCA), briefly setup a business goal through the financial analysis (FIA), develop customer expectations (VOC), create explicit product requirements (MAR), and establish a global product strategy (WMP). Any potential risks shall be identified, analyzed and maintained by using the Market FMEA tool.

Technical service group shall build customer service requirements (TSP). Any potential risks shall be identified, analyzed and maintained by using the Service FMEA tool.

R&D group shall generate knowledge from any well-established engineering principles and the similar products (EPR), perform an initial assessment of overall technology challenge and feasibility toward the new product (TFA), develop system requirement specifications (SYR), human factor requirement specifications (HFR), and product reliability requirement specifications (REA). Any potential risks shall be identified, analyzed and maintained by using the System FMEA tool or application FMEA tool.

Medical science group shall generate any clinical knowledge from the predicate products (CLR), and define product clinical requirements (CSP). Any potential risks shall be identified, analyzed and maintained by using the Clinical FMEA tool.

Regulatory affair group shall analyze any substantial equivalence in markets (PRP), determine a regulatory classification for the new product (PRC), and plan regulatory submissions to the target markets (RAS). Any potential risks shall be identified, analyzed and maintained by using the Compliance FMEA tool.

Operations group shall plan project deliverables in supporting of the new product distribution & production activities (OPS), and develop an effective supply chain strategy (SCP). Any potential risks shall be identified, analyzed and maintained by using the Process FMEA tool.

Supplier quality group shall develop a supplier quality control strategy (SQP). Any potential risk shall be identified, analyzed and maintained by using the Supplier FMEA tool.

Product Design Phase: Once a project passes the phase review of product plan, it is ready to move to the product design phase.

Market group shall review related patents and is responsible to submit any new patents if available (IPR), identify top level product features (PRD), apply for product names and trademarks (TRB), and develop marketing communication materials (MCM). Any potential risks shall be identified, analyzed and maintained by using the Market FMEA tool.

Technical service group shall develop a user manual and release notes (USM) and use Service FMEA to identify, analyze, and maintain the potential risks.

R&D group shall create design descriptions, design architectures (SYCD), frameworks, schematics, sketches, block diagrams, and layouts (SYAD) in a top level. R&D group shall identify potential biological hazards (PBE), ensure new designs to use the most current environmental materials (DFE), predicate a system failure rate (REP), document system design specifications (SYS), trace design activities (DTM), establish system level tests (SIT), verify the design is safe for human use (RST), determine a product shelf life (PSLS), and prepare documents for regulatory submissions (DHFR). Any potential risks above shall be identified, analyzed and maintained by using the System FMEA tool;

R&D group shall identify the known or foreseeable usability hazards (HFD), develop human factor specifications (HFS), and initiate usability verification tests (SUT). Any potential risks above shall be identified, analyzed and maintained by using the Application FMEA tool;

R&D group shall develop hardware requirements (HWR) & structures (HAD), build drawings/specifications/BOMs (HWDD, HWS), initiate hardware verification tests (HDVT), and hardware reliability tests (HRT). Any potential risks above shall be identified, analyzed and maintained by using the Design FMEA tool;

If applicable, R&D group shall develop software requirements (SWR) & structures (SAD), software codes (SWDD), code reviews (SWS), software configuration control activities (SWC).

R&D group shall initiate software verification tests (SDVT), software integration tests (SWIT), software system level tests (SST), and unresolved anomalies (SUB). Any potential risks above shall be identified, analyzed and maintained by using the Software FMEA tool.

Medical science group shall determine safety and efficacy requirements (SER) and demonstrate without any significant clinical adverse events existed by means of the product performance tests on referred non-animal tissues (DRT), animal/human organisms (WT), and animal models (ANT). The group shall build an investigator brochure (CIB), prepare & submit clinical documents for the EC/CA approvals (CAD), conduct clinical studies (CIS), evaluate clinical data (CDE), provide evidences weather medical benefits outweigh risks (RBA). Any potential risks above shall be identified, analyzed and maintained by using the Clinical FMEA tool.

Regulatory affair group shall define regulatory submission requirements in target markets (PSR), determine international standards in supporting of the product development and regulatory submission (ASR), generate essential requirement checklists (ERC), apply for Declaration of Conformity (DOC), apply for FIM CA approvals for the FIM clinical studies (FIMS, ECCA), apply for IDE permit from IRB or FDA for clinical studies (IDES, IRB), and apply for global regulation certificates (TFS, DDS, 510k, PMA). Any potential risks above shall be identified, analyzed and maintained by using the Compliance FMEA tool.

Operations group shall define manufacturability requirements (MAR), develop an optimal purchasing strategy (PUP) & cost targets (DTC), adopt the internationally recognized label symbols (LAD), verify the integrity & legibility of the labels (LDVT), design & develop related assistant equipment (gage, tooling, or fixture) (GTFD), and build an optimal production process (CYP). Any potential risks above shall be identified, analyzed and maintained by using the Process FMEA tool;

Operations group shall define package requirements (PAR), ensure the package free from damage & comply with sterile requirements (PAD), and verify the integrity of product packaging (PDVT). Any potential risks above shall be identified, analyzed and maintained by using the Package FMEA tool.

Supplier quality group shall define supplier evaluation requirements (SQR), supplier selection and qualification activities (SSQ). The group shall acquire approved supplier lists (ASL), ensure supplier materials to meet the design specifications (SPQ), and develop recommended inspection procedures to perform FAI (SFAI). Any potential risks above shall be identified, analyzed and maintained by using the Supplier FMEA tool.

Process Development Phase: Once a project passes the phase review of product design, it is ready to move to the process development phase.

Regulatory affair group shall acquire product market permits including CE Marking (CEM), the Rest of World (Canada, China, Japan, Mexico, South Korea, Taiwan, Australian, India, Philippine, Russia, etc.) (ROW). Any potential risks above shall be identified, analyzed and maintained by using the Compliance FMEA tool.

Operations group shall develop processes for packaging (PPD), sterilization (SPD) and manufacturing (MPD). The group shall plan a process validation (MVP) and execute validation activities for measurement system (MSAV), sterilization process (SPV), manufacturing process (MPV), and cleanrooms & facility environment (CRFV). The group shall create new part numbers (DMR), evaluate product stability (PSE) & costs (DCOG), and ensure the customized equipment (machinery, equipment, workstation, etc.) to compliance with ergonomics, health, safety, and environmental requirements (EHSC). Any potential risks above shall be identified, analyzed and maintained by using the Process FMEA tool.

Operations group shall develop optimal process parameters for packaging process (PPD), and validate them (PPV). Any potential risks above shall be identified, analyzed and maintained by using the Package FMEA tool.

Supplier quality group shall validate supplier manufacturing processes and equipment (SPV), and generate supplier quality agreements (SQA). Any potential risks above shall be identified, analyzed and maintained by using the Supplier FMEA tool.

Product Launch Phase: Once a project passes the phase review of process development, it is ready to move to the product launch phase.

Market group shall develop a product launch plan (GML), summarize a detailed financial analysis (REM), launch a post market surveillance (PMS), and develop a process for the regulation recalls (FDA, EU, Health Canada, etc.) (RFA). Any potential risks above shall be identified, analyzed and maintained by using the Market FMEA tool.

Technical service group shall define customer service requirements (CSR), develop a calibration & preventative maintenance program (PCM), and release a service manual including a detailed information for installing, testing, troubleshooting, and maintenance (SEM). Any potential risks above shall be identified, analyzed and maintained by using the Service FMEA tool.

Medical science group shall assess safety and performance in the post markets (PCS). Any potential risks above shall be identified, analyzed and maintained by using the Clinical FMEA tool. Regulatory affair group shall develop a process in order to submitting medical device reports to the FDA or EU (MDR). Any potential risks above shall be identified, analyzed and maintained by using the Compliance FMEA tool.

Operations group shall develop production procedures (PWI) for managing manufacture activities, build test methods (PRT) for detecting latent product defects, create a preventative maintenance program for maintaining production equipment (ECM), and establish a product identification & traceability throughout all production stages (PIT). Any potential risks above shall be identified, analyzed and maintained by using the Process FMEA tool.

Supplier quality group shall develop a supplier performance monitor and control process (SPMC), and create a process for using SCAPA system (SCAPA). Any potential risks above shall be identified, analyzed and maintained by using the Supplier FMEA tool.

### REFERENCES

Xiao, Jin Xing (2013). Risk Driven Product Development System. Patent publication # US-2015-0134398-A1, The United States Patent and Trademark Office, The Department of Commerce.

Morgan, J.; Liker, J. (2006). The Toyota Product Development System: Integrating People, Process and Technology. ISBN-10: 1563272822, Productivity Press, New York.

Oehmen, J.; Seering W. (2011). Risk-Driven Design Process: Balancing Efficiency with Resiliene in Product Design. The future of Design Methodology, Springer-Verlag London Limited, p 47-54.

I claim:

1. Risk driven Product Development Process (RdPDP) is a systematic method for facilitating a new product development driven by real-time risk management. It establishes a general framework which consists of 4 phases (product plan, product design, process development, and product service) and of 13 sub-phases (business case, market requirement, design input, designing, design output, design verification, design validation, design transfer, process development, process validation, process transfer, manufacturing, and product service). It collaborates the cross-functional teams together (Market, technical service, R&D, Medical Science, Regulatory Affairs, Supply Chain, Quality, Risk Management, and Project team). It creates an intuitive project deliverable requirement map to guide the project development and implement the project risk management in real time.

2. Risk driven Product Development Process (RdPDP) manages risks on individual project deliverable in real time. An example map with 166 project deliverable requirements are provided below which demonstrates that the new product is in line with the physical features (mechanical, electrical, software components), reliability features (re-usable, shelf life), biocompatibility features, and regulatory affairs requirements (FDA, EU, ROW).
a) In the product plan phase, the invention can lead risk management to the following project deliverables:
MCA, FIA, VOC, MAR, and WMP by using the Market FMEA tool
TSP by using the Service FMEA tool
EPR, TFA, SYR, REA by using the System FMEA tool
HFR by using the Application FMEA tool
CLR, and CSP by using the Clinical FMEA tool
PRP, RAS, and PRC by using the Compliance FMEA tool
OPS, SCP by using the Process FMEA tool
SQP by using the Supplier FMEA tool
b) In the product design phase, the invention can lead risk management to the following project deliverables:
IPR, PRD, TRB, MCM by using the Market FMEA tool
USM by using the Service FMEA tool
SYCD, SYAD, PBE, DFE, REP, SYS, DTM, SIT, RST, PSLS, SRT, DHFR by using the System FMEA tool
HFD, HFS, SUT by using the Application FMEA tool
HAD, HWR, HWDD, HWS, HDVT, HRT by using Design FMEA tool
SAD, SWR, SWDD, SWS, SWC, SDVT, SWIT, SST, SUB, SWR by using Software FMEA tool
SER, DRT, IVT, ANT, CIS, CIB, CAD, CDE, RBA by using the Clinical FMEA tool
PSR, ASR, ERC, DOC, FIMS, IDES, ECCA, IRB, TFS, DDS, PMN, PMA by using the Compliance FMEA tool
MAR, PUP, DTC, LAD, GTFD, LDVT, CYP by using the Process FMEA tool
PAR, PAD, PDVT by using the Package FMEA tool
SQR, SSQ, ASL, SPQ, SFAI by using the Supplier FMEA tool
c) In the process development phase, the invention can lead risk management to the following project deliverables:
CEM, ROW by using the Compliance FMEA tool
MVP, SPD, MPD, MSAV, SPV, MPV, CRFV, DMAR, PSE, EHSC, DOCG by using the Process FMEA tool
PPD, PPV by using the Package FMEA tool
SPV, SQA by using the Supplier FMEA tool
d) In the product launch phase, the invention can lead risk management to the following project deliverables:
GML, REM, PMS, RFA by using the Market FMEA tool
CSR, PCM, SEM by using the Service FMEA tool
PCS by using the Clinical FMEA tool
MDR by using the Compliance FMEA tool
ECM, PIT by using the Process FMEA tool
SPMC, SCAPA by using the Supplier FMEA tool

3. According to claim 1, the cross functional teams are able to be modified (added, deleted, merged, replaced, corrected, etc.) if any organizational structures are changed.

4. According to claim 1, the RdPDP phases and sub-phases are able to be modified (added, deleted, merged, replaced, etc.) if any phase configurations are changed.

5. According to claim 2, the project deliverables above are able to be modified (added, deleted, merged, replaced, corrected, etc.) if any product features are changed.

6. According to claim 2, product development projects can not be moved to the next sub-phase or phase unless the overall potential risks are reduced as far as possible (AFAP) and the benefits outweigh the risks.

7. According to claim 2, mitigated actions are required if any residual potential risks within the project deliverables are unacceptable. The mitigated actions may not be required further unless the potential risks have been reduced as far as possible and the benefits outweigh the risks.
